(19) United States
(12) Patent Application Publication
(10) Pub. No.: US 2010/0018157 A1
(43) Pub. Date: Jan. 28, 2010

(54) CLOSING MACHINE FOR SCREWING SCREW TYPE CAPS ONTO SCREW TOP BOTTLES IN A BEVERAGE BOTTLING PLANT AND CLOSING MACHINE FOR SCREWING SCREW TYPE CAPS ONTO SCREW TOP CONTAINERS

(76) Inventor: Volker Till, Hofheim am Taunus (DE)

Correspondence Address: NILS H. LJUNGMAN & ASSOCIATES, P. O. BOX 130, GREENSBURG, PA, 15601-0130, US

(21) Appl. No.: 12/356,119

(22) Filed: Jan. 20, 2009

Related U.S. Application Data
(63) Continuation-in-part of application No. PCT/EP2007/006324, filed on Jul. 17, 2007.
Application No. PCT/EP2007/006324 is a continuation-in-part of application No. PCT/EP2007/006306, filed on Jul. 17, 2007.

(30) Foreign Application Priority Data
Jul. 20, 2006 (DE) 10 2006 033 511.2
Jul. 31, 2006 (DE) 10 2006 035 279.3

(51) Int. Cl. B67C 7/00; B67B 3/20

(52) U.S. Cl. 53/281; 53/317

(57) ABSTRACT

A closing machine for screwing screw type caps onto screw type bottles in a beverage bottling plant and a closing machine for screwing screw type caps onto screw type containers. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2007/006324, filed on Jul. 17, 2007, which claims priority from Federal Republic of Germany Patent Application No. 10 2006 035 279.3, filed on Jul. 31, 2006, as well as a Continuation-In-Part application of International Patent Application No. PCT/EP2007/006306, filed on Jul. 17, 2007, which claims priority from Federal Republic of Germany Patent Application No. 10 2006 033 511.2, filed on Jul. 20, 2006. International Patent Application Nos. PCT/EP2007/006324 and PCT/EP2007/006306 was pending as of the filing date of this application. The United States was an elected state in International Patent Application Nos. PCT/EP2007/006324 and PCT/EP2007/006306.

### BACKGROUND

1. Technical Field

The present application relates to a beverage bottling plant with an apparatus for closing screw caps onto screw top bottles in a beverage bottling plant and a closing machine for screwing screw type caps onto screw top containers.

2. Background Information

Background information is for informational purposes only and does not necessarily admit that subsequently mentioned information and publications are prior art.

A beverage bottling plant for filling bottles with a liquid beverage filling material can possibly comprise a beverage filling machine, which is often a rotary filling machine, with a plurality of beverage filling positions, each beverage filling position having a beverage filling device for filling bottles with liquid beverage filling material. The filling devices may have an apparatus designed to introduce a predetermined volume of liquid beverage filling material into the interior of bottles to a substantially predetermined level of liquid beverage filling material.

Some beverage bottling plants may possibly comprise filling arrangements that receive a liquid beverage material from a toroidal or annular vessel, in which a supply of liquid beverage material is stored. The toroidal vessel may also be connected to at least one external reservoir or supply of liquid beverage material by a conduit or supply line. In some circumstances it may even be possible that a beverage bottling plant has two external supply reservoirs, each of which may be configured to store either the same liquid beverage product or different products. These reservoirs could possibly be connected to the toroidal or annular vessel by corresponding supply lines, conduits, or other arrangements. It is also possible that the external supply reservoirs could be in the form of simple storage tanks, or in the form of liquid beverage product mixers.

A wide variety of types of filling elements are used in filling machines in beverage bottling or container filling plants for dispensing a liquid product into bottles, cans or similar containers, including but not limited to filling processes that are carried out under counterpressure for the bottling of carbonated beverages. The apparatus designed to introduce a predetermined flow of liquid beverage filling material further comprises an apparatus that is designed to terminate the filling of the beverage bottles upon the liquid beverage filling material reaching the predetermined level in bottles. There may also be provided a conveyer arrangement that is designed to move bottles, for example, from an inspecting machine to the filling machine.

After a filling process has been completed, the filled beverage bottles are transported or conveyed to a closing machine, which is often a rotary closing machine. A revolving or rotary machine comprises a rotor, which revolves around a central, vertical machine axis. There may further be provided a conveyer arrangement configured to transfer filled bottles from the filling machine to the closing station. A transporting or conveying arrangement can utilize transport star wheels as well as linear conveyors. A closing machine closes bottles by applying a closure, such as a screw-top cap or a bottle cork, to a corresponding bottle mouth. Closed bottles are then usually conveyed to an information adding arrangement, wherein information, such as a product name or a manufacturer's information or logo, is applied to a bottle. A closing station and information adding arrangement may be connected by a corresponding conveyer arrangement. Bottles are then sorted and packaged for shipment out of the plant.

Many beverage bottling plants may also possibly comprise a rinsing arrangement or rinsing station to which new, non-return and/or even return bottles are fed, prior to being filled, by a conveyer arrangement, which can be a linear conveyor or a combination of a linear conveyor and a starwheel. Downstream of the rinsing arrangement or rinsing station, in the direction of travel, rinsed bottles are then transported to the beverage filling machine by a second conveyer arrangement that is formed, for example, by one or more starwheels that introduce bottles into the beverage filling machine.

It is a further possibility that a beverage bottling plant for filling bottles with a liquid beverage filling material can be controlled by a central control arrangement, which could be, for example, a computerized control system that monitors and controls the operation of the various stations and mechanisms of the beverage bottling plant.

At least one possible embodiment relates to a closing machine for closing of containers, such as for instance, bottles, having numerous different design executions, possibly also as machines of the rotating or carousel style in which there is a plurality of closing stations disposed at the circumference of a driven rotor, with the rotor being configured to rotate about a vertical machine axis, and, possibly, respectively the closing stations are associated with a closing tool, which closing tool is configured to close, under use of a drive arrangement which is configured to provide the motive force to secure the closure at the container, with the closure, for example, previously having been placed atop at the mouth of the container which is to be closed. As well, possibly, some closing machines for closing of containers with screw caps which are screwed, for the purpose of closing of the bottles, onto a bottle mouth, upon having been positioned at the bottle mouth, onto a thread formation formed at the container mouth, and by turning of the screw caps, the screw caps are then secured by means of a drive arrangement for closing (e.g., a spindle drive arrangement for closing) of the relevant closing station or closing arrangement, which closing drive arrangement is driven so as to be rotated, and may be configured as a conically shaped closing structure or arrangement. During the closing step or phase the respective closing tool or arrangement and the container are moved relative with respect to one another, namely, for instance, by another drive arrangement for closing, e.g., also in form of a lifting and lowering arrangement that is working under the control or direction of a pertaining control arrangement.

It may be necessary in the case of closing machines that the closing tools or arrangements are adapted in each case to the possible type and/or size of the closures, so that for a re-tooling or changing of pertaining tools of the closing machine from a first closure type and/or closure size to another closure type and/or size (also referred to herein as format change), changes of the closing tools or arrangements are also desired in each closing station or closing arrangement of a closing machine, which hitherto is associated with effort that is time consuming and labor intensive.

### OBJECT OR OBJECTS

The object of at least one possible embodiment of the present application is to describe an apparatus with which tools can be readily changed in a closing machine wherein a first tool being configured to receive and rotate a cap of a first size is operably engaged with the closing machine and is changed with a second tool to operably engage the closing machine, the second tool being configured to receive and rotate a cap of a second size.

### SUMMARY

At least one possible embodiment according to the present application teaches that this object can be accomplished by providing a closing machine which is configured as a closing machine for closing of bottles or like containers with closures, with several closing stations or closing arrangements that are disposed at a circulating rotor configured to be rotated, and are respectively provided with one closing tool or arrangement for securing of the closure to the container that is disposed at a respective closing station or closing arrangement. For every closing station or closing arrangement, there are provided two closing tools or arrangements that are held at one tools bearer, and that by moving of the tools bearer the closing tools or arrangements of at least one closing station or closing arrangement can be moved, for the purpose of effecting a tool exchange or a format and/or size exchange, between a working position, in which the closing tool or arrangement effectuates the fixing of closures at containers and a loading position.

In the apparatus according to at least one possible embodiment according to the present application, a closing machine having a plurality of closing stations or closing arrangements with each being provided at least two closing tools or arrangements which are moveable, together with a tools bearer between a working position, in which the relevant closing tool or arrangement causes closing of the associated container, and a supplying position. By means of this configuration, there is provided the possibility to assign to every closing station or closing arrangement at least two closing tools or arrangements which are suitable for two different closure types or kinds and/or closure dimensions, so that a quick and unproblematic format change is possible.

In at least one possible embodiment of the present application, the closing tools or arrangements of all closing stations or closing arrangements, or, however, at least of a group of closing stations or closing arrangements, are disposed in or at a common tools bearer, so that upon moving this tools bearer, or the tools bearer common for closing stations or closing arrangements, a change of format of closures is possible.

In one possible embodiment form, the closing tools or arrangements are disposed at a ring-shaped bearer which concentrically surrounds the vertical machine axis and which is configured to be turned or swung, for the purpose of the tools change, around this machine axis, or is swung, in such a manner that all closing tools or arrangements of the first type, which were in the working position prior to the format change, are substituted, after completion of the format change, by a closing tools or arrangements of the second type, which previously were held in a loading position prior to the format change.

The closing tools or arrangements are configured, for instance, as conically shaped closing structures or arrangements for the processing of closures that can be turned or rotated so as to be secured on a thread formation at the mouth of a bottle, for example; and for this purpose these conical closing arrangements are respectively held at the tools bearer, in such a way so as to permit turning about a tool axis. At the latest at the commencement of every closing process or closing step or, however, already while moving a closing tool or arrangement into the working position, it is respectively connected in a manner so as to be driven by the drive arrangement of a screw type unit and a closing unit of the respective closing station or closing arrangement with which (a screw type unit and a closing unit) the closing tool or arrangement is then driven in a rotating manner while closing is performed. In order so as to attain a reliable coupling of the closing tools or arrangements to the respective screw type unit and a closing unit or arrangement, in one possible embodiment there are provided means which arrest or secure the closing tools or arrangements in the supplying position in at least one predetermined rotary position of the pertaining rotation, in such a manner that each closing tool or arrangement, that is moved from a loading position into a predetermined operating or working position, is being located at the rotary position of the pertaining rotation that is desired for connecting of the pertaining screw type unit and a closing unit or arrangement.

In other words, a possible embodiment provides a means for providing closing tools from a storage position to a loading position in an orientation that is configured to receive a closing unit.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Developments of at least one possible embodiment are described according to the present application. At least one possible embodiment is explained in greater detail below on the basis of the exemplary embodiment illustrated in the accompanying figures, in which:

FIG. 1 is a simplified illustration of a bottle closed with a screw cap;

FIG. 2 is a simplified plan view of a closing machine of the rotating or carousel type;

FIG. 3 is a simplified illustration of one embodiment of a closing unit;

FIG. 4 is a simplified side-elevational view of a portion of a rotor and two closing units provided therewith and closing tools in a tools bearer, whereby the components are shown, for reasons of improving clarity, in a condition in which the various elements are shown spaced apart;

FIG. 5 is a simplified plan view of a ring-shaped tools bearer having first and second closing tools;

FIG. 6 is a simplified illustration of a ring-shaped centering element that is also configured as a securing element of the closing machine;

FIG. 7 is a simplified illustration of a closing machine;

FIG. 8 is a simplified illustration of a bottling plant; and

FIG. 9 is a simplified schematic of another possible embodiment of a system for filling and closing containers.

### DESCRIPTION OF EMBODIMENT OR EMBODIMENTS

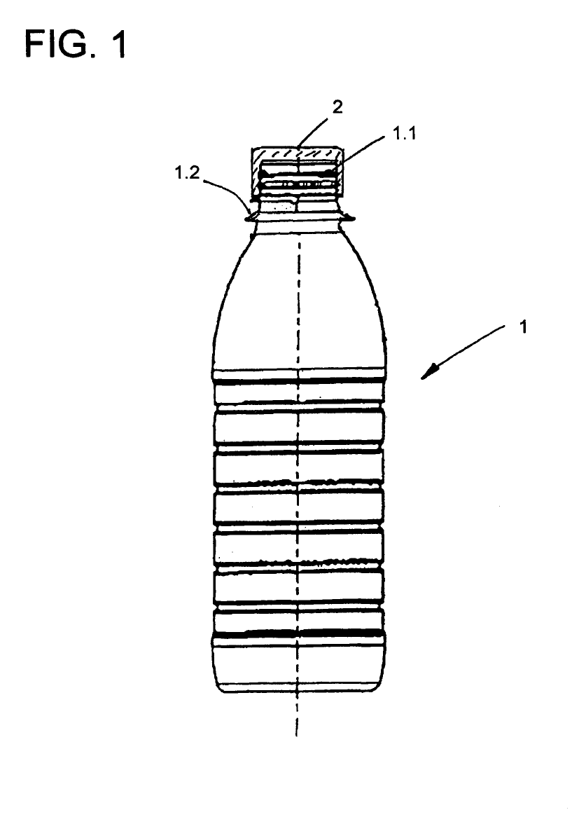

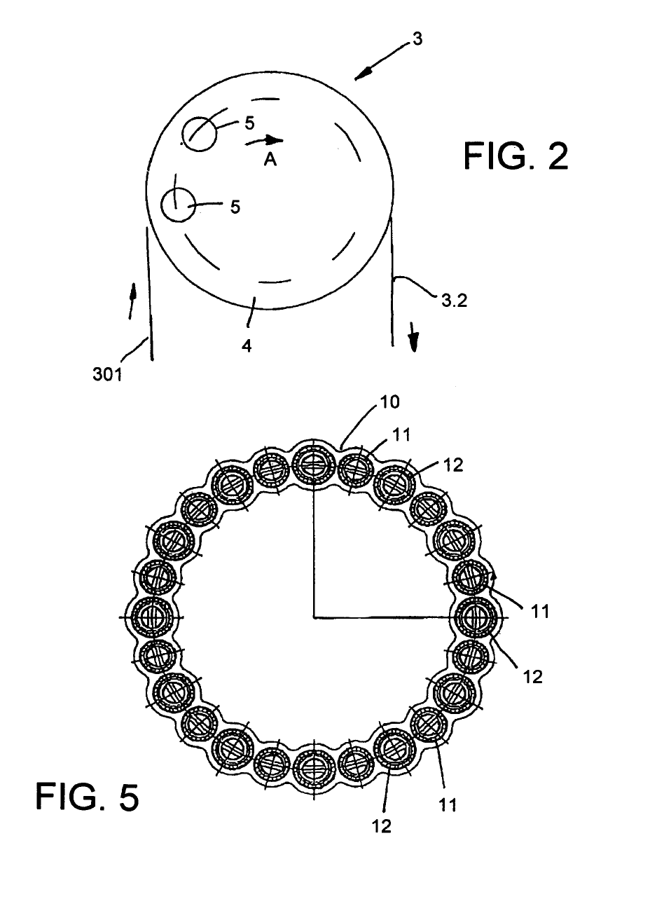

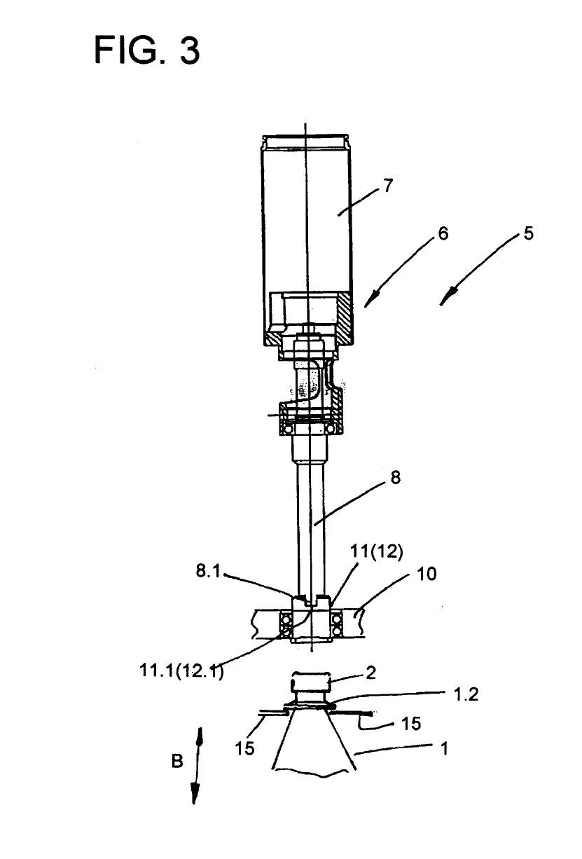

In the drawing figures, a container 1 is in the form of a bottle which is closed by a screwed-on closure, shown in FIG. 1 in the configuration of a cap 2, that is depicted in cross-section. Closing of the bottles 2 is achieved in the manner basically known to the man with skill in the art of such closing machine 3, of which in FIG. 2 is shown schematically a powered rotor 4 that is configured to rotate about a vertical machine axis; and at the periphery of the rotor 4 there are disposed several closing stations or closing arrangements 5. The bottles 1 to be closed are supplied at a bottle input arrangement 3.1 of the closer or bottle closer arrangement, respectively to a closing station or closing position 5. The closed bottles 1 are taken from the respective closing station or closing position 5 by way of a bottle outlet 3.2 and are then supplied to another operational phase or another use.

In the arcuate or angle-region pertaining to the rotating movement of the rotor 4 (angle A), between the bottle input arrangement 3.1 and the bottle outlet 3.2, a closure 2 is placed, as a first step, onto every bottle 1 and, for closing of the bottle 1, the closure 2 is then is screwed onto the thread formation or threading 1.1 at the bottle mouth by way of turning of the cap.

For attaching or securing of the closures 2, on the bottles 1, every closing station or closing position 5 comprises a closing unit or structure or arrangement 6 which comprises, among other things, a drive arrangement 7 and a spindle arrangement 8 with a spindle portion that is freely extending downwardly from the bottom of the drive arrangement 7 with its free end, and which spindle arrangement 8 has a spindle axis which is disposed with respect to the vertical machine axis MA in such a way that the respective axes are precisely or generally coordinated with respect to one another in co-incidental manner. Every spindle arrangement 8 is configured at the lower free end with a connecting or clutch segment spindle arrangement 8.1 which is embodied in reference to the shown embodiment as a ridge or projection generally configured to carry out the function of or perform the action a feathering-key or key structure. The lower end of every spindle arrangement 8 is guided in a centering and securing ring or arrangement 9 and this element 9 is secured to rotor 4 and element 9 is arranged with its reference to the machine axis MA in such a way that the respective axes are coordinated with respect to one another in co-incidental manner. In the region beneath the ring 9 a ring-shaped tools bearer 10 is arranged, which likewise surrounds the vertical machine axis MA in a manner such that the respective components are concentrically disposed with respect to one another, or, respectively, it is arranged so as to be in axis-correlated manner with reference to the machine axis MA in such a way that the respective axes are coordinated in co-incidental manner.

In the tools bearer 10 several conically shaped closing structures or arrangements 11 and 12 are journaled in such a way that they can freely rotate, namely in each case around a vertical axis which is disposed in such a way with respect to the machine axis MA that the respective axes are precisely or generally coordinated in parallel or virtually parallel attitude with respect to one another. The conically shaped closing structures or arrangements 11 and 12 are adapted to different dimensions of the closures 2, namely, such that the conically shaped closing structures or arrangements 11 are suitably configured to perform processing of closures 2 with a certain smaller diameter and the conically shaped closing structures or arrangements 12 are suitably configured for processing of closures with a certain larger diameter.

As is particularly pointed out in the embodiment shown in FIG. 5, the conically shaped closing structures or arrangements 11 and 12 are arranged, when considered in the direction of the circumference of the tools bearer 10, in such a way that all conically shaped closing structures or arrangements 11 and 12 are positioned in each case at the same radial distance from the central axis of the tools bearer 10 and, thus, also from the machine axis MA, with the magnitude of this respective radial distance being equal to the distance between the axis spindles 8 and the machine axis MA. As the FIG. 5 shows, furthermore, the conically shaped closing structures or arrangements 11 and 12 are positioned, when considered in the circumferential direction of the tools bearer 10, in an alternating manner, namely, in such a way that in each case a conically shaped closing structure or arrangement 11 and a conically shaped closing structure or arrangement 12 form a conically shaped closing structure, or a pair of conically shaped closing structures, or an arrangement pair, or a group of conically shaped closing structures or arrangements, which in relative disposition with respect to the machine axis MA cover an arcuate region that is of lesser size than the distance between the axes of two successively disposed closing units or arrangements 6, when considered in the direction of the periphery of the rotor 4. Furthermore the number of conically shaped closing units or structures or arrangement-groups is equal to that of the number of the closing structures or arrangements 6, so that to every closing structure or arrangement there is assigned, in accordance with the shown embodiment, a conically shaped closing structure or arrangement 11 and a conically shaped closing structure or arrangement 12.

By turning or, respectively, by swinging of the tools bearer 11 around the machine axis MA, there can be selectively positioned, accordingly, a conically shaped closing structure or arrangement 11 or a conically shaped closing structure or arrangement 12 in alternating manner at the lower end of the accompanying spindle arrangement 8 configured for turning a closure to secure the closure, with the respective axes being substantially coincidentally disposed; this positioning function providing i.e. in a working position, namely in one possible embodiment also in such a way that the connecting or clutch segment 8.1 of each spindle arrangement 8 interacts with a clutch segment 11.1 or 12.1 of the respective conically shaped closing structure or arrangement 11 or 12 that is located in the working position. With the embodiment of the clutch segments 8.1 as an element or structure that is configured to perform the functions of a feathering-key or key structure, the segments 11.1 and 12.1 are configured at the upper side of the conically shaped closing structures or arrangements 11 and 12 and in each case these elements 11.1 and 12.1 are configured as a suitable slit or like formation. The respective drive arrangement 7 for the closing units or arrangements 6 is embodied by means, i.e., in at least one embodiment they are configured as motors or other drive arrangements or operative motive power generator for elements 8 and the means or elements 7 are controlled and configured in such a way that the spindle arrangements 8, after completion or conclusion of each pertaining closing phase or screwing phase for a respective cap, or, however, also for the initial phase or introduction of a format change can be arranged at a commencement position or change position, and in their respective position every clutch segment spindle arrangement 8.1 with its greater surface 8.1.1 which is disposed in vertically disposed planes, is generally disposed so as to be located tangentially with respect to the circumference, or with respect to the rotation direction as schematically indicated by arrow A of the rotor 4.

At the bottom or underside of the centering and securing ring or arrangement 9 there is provided a spring-like projection 9.1 which is configured to perform the functions of a feathering-key or key structure or arrangement, which ridge formation 9.1, however, is discontinuous so as to provide a respective gap at the region as is shown by region 14 which region or gap or like formation is located there where the respective spindle arrangement 8, at its lower terminus, is guided in a bore or similar formation 13 of the ring 9, or, the respective spindle arrangement 8, at its lower terminus, is guided in a bearing arrangement respectively arranged at every interruption 14, so that the respective clutch segment 8.1 of a spindle arrangement 8 is taken up and received, upon being in the starting position or commencement position for closing; in the respective gap formation 14 of the respective closing structure or arrangement 6, or, respectively of the spindle arrangement 8 configured for turning a closure to secure the closure, such that the upper surface sides 8.1.1 of every clutch segment 8.1 are respectively in operative engagement with lateral surface sides 9.1.1 of the ridge or projection 9.1.

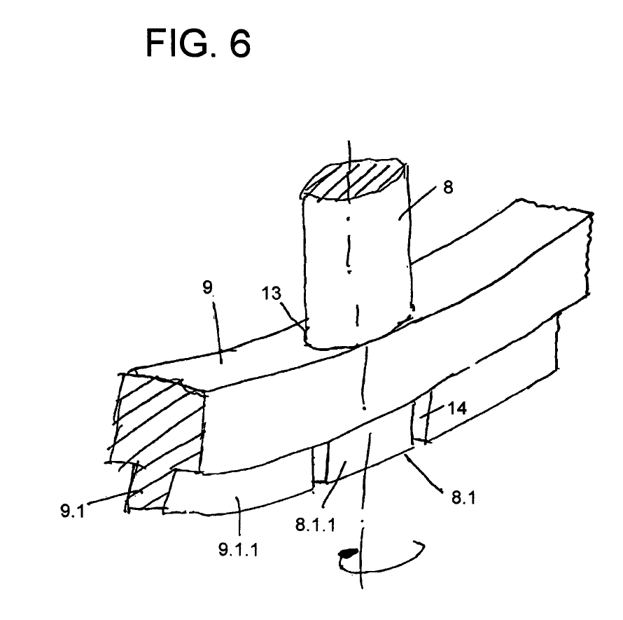

In other words, as shown in FIG. 6, one embodiment may have a securing ring or arrangement 9 with gap spaced spring-like projections 9.1. The gap space 14 between each projection 9.1 is configured to receive a clutch segment 8.1. Upper surface sides 8.1.1 of each clutch segment 8.1 are respectively in operative engagement or alignment with lateral surface sides 9.1.1 of the ridge or projection 9.1 as to form a ridge or projection extending below centering ring 9. This configuration provides the function of a feathering-key or key structure or arrangement that is configured for continuous engagement of clutch segments 11.1 and 12.1 with projections 9.1 and clutch segments 8.1 as connecting ring 9 is rotated about a central machine axis. This engagement provides a means for providing closing tools 11 and 12 from a storage position to a loading position in an orientation for connecting to a closing unit 6.

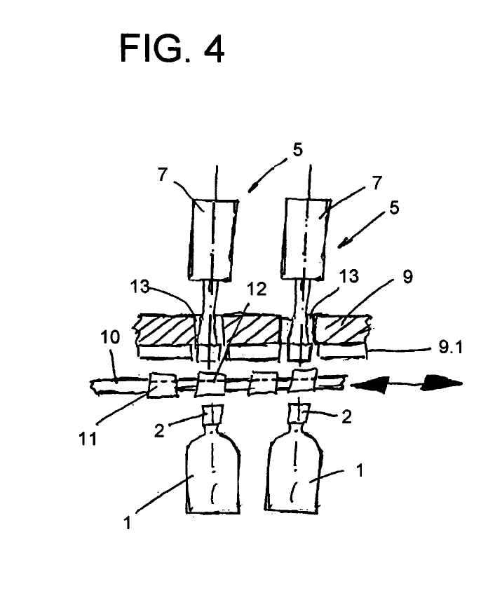

In contrast to the embodiment depicted in FIG. 4, which for reasons of improving clarity shows a condition in which the various elements are shown spaced apart, that is, for example, elements which are normally disposed in the working position close to one another so that they are connected to one another, in this illustration they are shown in a separated condition, the projection 9.1 reaches into the clutch segment 11.1 or 12.1 when in the assembled condition that is, while in the condition in which elements of the equipment are assembled for operation and it respectively reaches in each case into the clutch segment 11.1 or 12.1 of those conically shaped closing structures or arrangements 11 and 12 which are presently not connected to a spindle arrangement 8, but which are in a supplying position or phase, so that also these presently and/or momentarily not-in-use conically shaped closing structures or arrangements 11 or 12 are disposed, as achieved by the projection 9.1, to be precisely disposed or generally disposed in the orientations or positions of rotation with regard to their respective clutch segments 11.1 and 12.1. Thus, in order to perform the actions of a format and or size change, of such arrangement, it is possible to uncouple the conically shaped closing structures or arrangements 11 or 12 that are located in the working position of the spindle arrangements 8 configured for turning a closure, thereby to secure the closure, either manually or by motorized turning or rotating of the tools bearer 10 and to couple other conically shaped closing structures or arrangements 12 or 11, which had been till then been maintained in the supplying position, to the spindle arrangements 8 configured for turning a closure to secure the closure, precisely or generally as to position and with respect to the positions of axes in such a way that the respective axes are precisely or generally coordinated with respect to one another.

Closing of the bottles 1 with the closures 2 occurs in the way known in the art of closing machines. For instance, a closure 2, firstly, is conveyed or passed into every conically shaped closing structure or arrangement 11. Subsequently, the relevant bottle 1 is oriented by means of a container bearer 15 that can be raised and lowered by means of a drive arrangement that is configured to provide such movements; with the bottle axis being disposed in the vertical direction and in such a way that the respective axes are co-incidentally disposed with the axis of a spindle arrangement 8 that is configured for turning a closure, so as to secure the closure of the relevant closing station or closing arrangement 5; and the bottle 1 is lifted or raised from below against a respective conically shaped closing structure or arrangement 11 or 12, with the spindle arrangement 8, being connected to elements 11 or 12, and with the spindle arrangement 8 being linked, that is, linked to the pertaining drive 7, so that for turning a closure to secure the closure according to the operation of the drive arrangement for closing, the closure 2 can then be screwed onto the bottle 1 by the conically shaped closing structure or arrangement 11 or 12, with the spindle arrangement 8 being powered by the drive arrangement for closing 7, i.e., to the thread 1.1 or like thread formation.

After closing thereof, the bottles 1 are lowered and are removed by way of the container outlet 3.2.

In the shown embodiment, each container bearer 15, associated with a respectively disposed closing station or closing arrangement 5, is configured in such a way that the bottles 1 are held at their neck portion, or, respectively at the flange structure 1.2 or flange formation that is formed thereat, while being closed, in a hanging or pending attitude at the container bearer 15. Of course, other arrangements of the container bearers are also possible.

The present application was described herein above with reference to one embodiment. It is understood that numerous changes as well as variations are possible, without thereby departing from the spirit and scope of the present application or the underlying thought or thoughts of the present application.

Thus, commencing from the fact at least alluded to in the foregoing, namely, that during and/or for closing of the bottles 1, the bottles 1 are raised or lifted here by the respective container or bottle bearer 15 from below against the conically shaped closing structure or arrangement 11 or 12, as used in each case, the conically shaped closing structures or arrangements 11 and 12 do not execute, during the closing phase any axial movement in the direction of their axes or in the direction of the axis of the respective spindle arrangement 8 configured for turning a closure to secure the closure. However, there basically exists also the possibility to provide the conically shaped closing structures or arrangements 11 and 12, e.g., in each case, for instance, fitted with springs in the tools bearer 10 in such a way that during closing a spring-like axial movement of the closing cones 11 or 12 that are presently and/or momentarily in use, is possible.

Furthermore, commencing from the fact at least alluded to in the foregoing, namely, that the conically shaped closing structures or arrangements 11 and 12 for all or essentially all or some of closing stations or closing arrangements 5 that are provided in a common tools bearer 10 are supported or journaled so as to permit turning or rotation thereof. However, basically there exists also the possibility to provide respectively its own tools bearer for every closing station or closing arrangement 5 or, however, a group of such closing station or closing arrangement, and in such embodiment then the respective closing cones are arranged so as to rotate or turn and, whereby, however, it is possible that all tools bearers are actuated together by one drive arrangement for the format and/or size change.

Likewise the present application also applies to such arrangements in which the clutch segments 8.1, in differentiation from the embodiment illustrated in FIG. 6, are not configured as a massive, substantially closed-periphery exhibiting bodies or structures with a substantially continuous or closed surface. For instance, the scope of the present application also includes such arrangements in which in place of the massive element merely two plugs reach into the respective groove of conically shaped closing structures or arrangements and, thus, produce the desired connection between the drive arrangement for closing 7 and the respective conically shaped closing structure or arrangement 11, 12. In such a case, these plugs can be journaled, for instance, at their respective upper ends, within the screw spindle arrangement 8 configured for turning a closure to secure the closure.

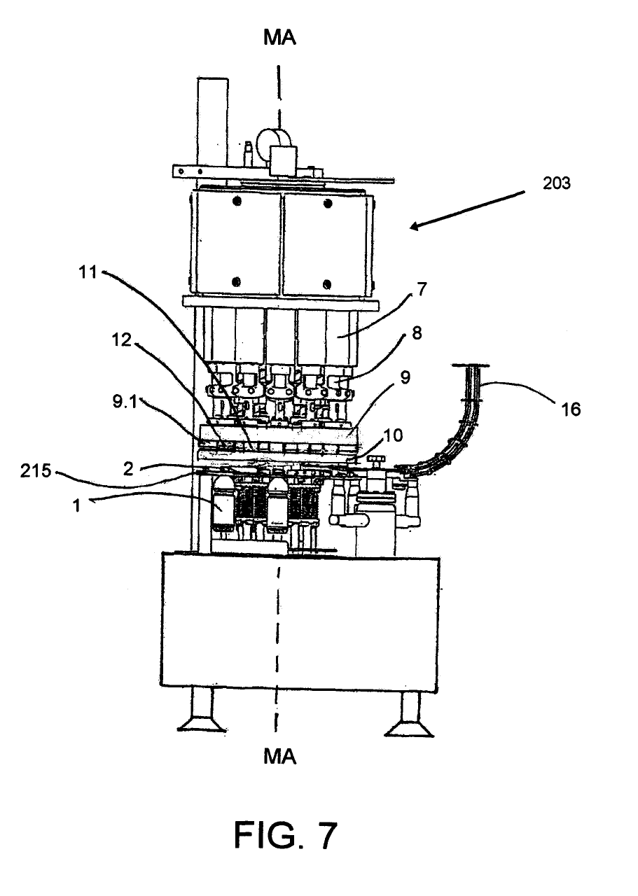

FIG. 7 illustrates one example of a capping or closing machine 203 for the capping of filled bottles 1. Such a capping machine may be disclosed in U.S. patent application Ser. No. 10/982,694, incorporated herein by reference in its entirety. In each capping position, a container or bottle bearer or holder 215 or portion thereof is provided to center and support a bottle 1 that is oriented with its vertical axis parallel to the axis of rotation MA of the capping machine 203. Above bottle holder 215, a spindle arrangement 8 is provided. Spindle arrangement 8 is rotatable about a vertical axis parallel to machine axis MA for turning a closure 2 to a secure position on bottle 1. A plurality of conically shaped closing structures or tools 12 are rotatably held with a bearing structure within support or carrying ring 10, each being interspersed with a conically shaped closing structure or arrangement 11. Conically shaped closing structures 12 are configured for a different size cap 2 than conically shaped closing structures 11. A conically shaped closing structure or closing tool 11 is shown in a quiescent storage position between spindle arrangements 8 and are rotatably retained within carrying ring 10. Closing tools 11 have an upper portion engaged with ridge, bar, keying, or feathering formation 9.1. Ridge 9.1 depends from centering ring 9 and is configured to engage the clutch segments in the upper portion of closing tools 11 or 12, maintaining them in a quiescent loading orientation in the loading position. Closing tools 12 are in a closing position with an upper portion engagable with a spindle arrangement 8.

During the rotation of the capping machine 203, the bottle holder 215 and thus also the associated container 1 executes a controlled vertical reciprocating motion, so that from each bottle 1, a screw cap 2 is placed thereon at screw cap delivery chute 16. Screw cap 2 is screwed onto container 1 by the rotation of spindle 8 with drive arrangement 7 and tightened to a desired torque with a conical closing tool 12.

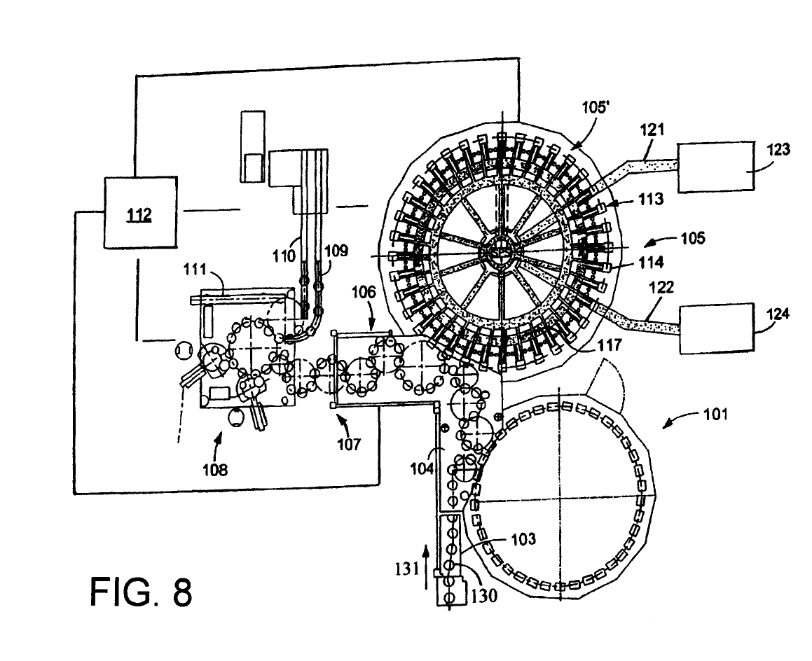

FIG. 8 shows schematically the main components of one possible example of a system for filling containers, specifically, a beverage bottling plant 100 for filling bottles 130 with at least one liquid beverage. Such a bottling plant may be disclosed in U.S. Pat. No. 7,415,816, incorporated herein by reference in its entirety. In accordance with at least one possible embodiment, in which system or plant could possibly be utilized at least one aspect, or several aspects, of the embodiments is disclosed herein.

FIG. 8 shows a rinsing arrangement or rinsing station 101, to which the containers, namely bottles 130, are fed in the direction of travel as indicated by the arrow 131, by a first conveyer arrangement 103, which can be a linear conveyor or a combination of a linear conveyor and a starwheel. Downstream of the rinsing arrangement or rinsing station 101, in the direction of travel as indicated by the arrow 131, the rinsed bottles 130 are transported to a beverage filling machine 105 by a second conveyer arrangement 104 that is formed, for example, by one or more starwheels that introduce bottles 130 into the beverage filling machine 105.

The beverage filling machine 105 shown is of a revolving or rotary design, with a rotor 105′, which revolves around a central, vertical machine axis. The rotor 105′ is designed to receive and hold the bottles 130 for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles 130 to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 8, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle B, the first product or the second product can be filled by means of an appropriate control of the filling product or fluid valves.

Downstream of the beverage filling machine 105, in the direction of travel of the bottles 130, there can be a beverage bottle closing arrangement or closing station 106 which closes or caps the bottles 130. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles 130. In the embodiment shown, the labeling arrangement 108 has three output conveyer arrangement: a first output conveyer arrangement 109, a second output conveyer arrangement 110, and a third output conveyer arrangement 111, all of which convey filled, closed, and labeled bottles 130 to different locations.

The first output conveyer arrangement 109, in the embodiment shown, is designed to convey bottles 130 that are filled with a first type of liquid beverage supplied by, for example, the supply reservoir 123. The second output conveyer arrangement 110, in the embodiment shown, is designed to convey bottles 130 that are filled with a second type of liquid beverage supplied by, for example, the supply reservoir 124. The third output conveyer arrangement 111, in the embodiment shown, is designed to convey incorrectly labeled bottles 130. To further explain, the labeling arrangement 108 can comprise at least one beverage bottle inspection or monitoring device that inspects or monitors the location of labels on the bottles 130 to determine if the labels have been correctly placed or aligned on the bottles 130. The third output conveyer arrangement 111 removes any bottles 130 which have been incorrectly labeled as determined by the inspecting device.

The beverage bottling plant can be controlled by a central control arrangement 112, which could be, for example, computerized control system that monitors and controls the operation of the various stations and mechanisms of the beverage bottling plant.

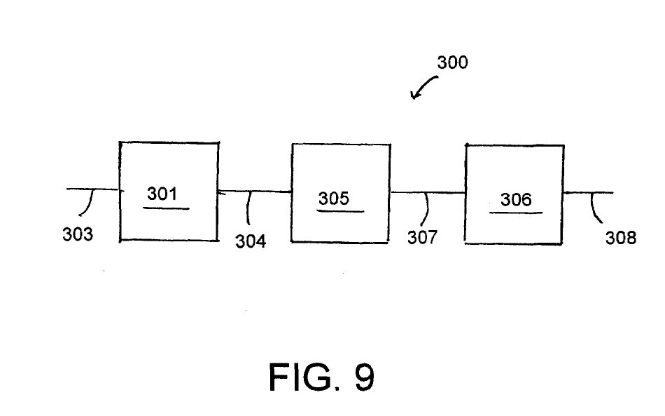

FIG. 9 shows schematically the main components of another possible example of a system for filling containers, specifically, a beverage bottling plant 300 for filling bottles or containers with at least one liquid beverage. FIG. 9 shows a rinsing arrangement or rinsing station 301, to which the bottles or containers are fed by a first conveyer arrangement 303, which can have a linear conveyor, a starwheel, or a combination of a linear conveyor and a starwheel. Rinsing station 301 may be of a revolving or rotary design or may have a liner design.

Downstream of the rinsing arrangement or rinsing station 301, the rinsed bottles or containers are transported to a beverage filling machine 305 by a second conveyer arrangement 304 that is formed, for example, by one or more starwheels, a linear arrangement, or a combination of both that introduce the bottles or containers into the beverage filling machine 305. The beverage filling machine 305 may have a revolving or rotary design or may have a linear design. The filling machine 305 may be designed to introduce a predetermined volume or amount of liquid beverage into the interior of the bottles or containers to a predetermined or desired level.

Downstream of the beverage filling machine 305, in the direction of travel of the bottles or containers, there is a beverage bottle closing arrangement or closing station 306 which closes or caps the bottles or containers. The filled bottles or containers are transported to the closing arrangement 306 by a third conveyer arrangement 307 that is formed, for example, by one or more starwheels, a linear arrangement, or a combination of both, that introduce the bottles or containers into the beverage closing station 306. The beverage closing station 306 may have a closing machine with a revolving or rotary design or may have a linear design. The beverage bottle closing arrangement or closing station 306 may be connected by a conveyer arrangement 308. Conveyer arrangement 308 may be formed, for example, by a plurality of starwheels, or may also include a linear conveyor device.

Closing station 306 may have a closing machine with at least one group of tools. Each group of tools has at least two tools, 11 and 12, but may have three or more tools. Each tool in each group of tool may be configured to rotate a different size cap 1. Each group of tools may be disposed in a linear arrangement or in a rotational arrangement. The closing machine has at least one rotator apparatus configured to rotate at least one of the first or the second tools with a torque sufficient to close the containers with the screw type closures. Each tool, 11 and 12, may have its own rotator apparatus or each group of tools may have a single rotator apparatus configured to rotate one of the tools in the group of tools. The closing machine may have a tools bearer configured to dispose and move the a tool in at least one group of tools into an operable position for engagement with one of the screw type closures 2 of the first size and to move the other tools each of the at least one group of tools into a non-operable position out of engagement with the screw type closures 2 of the first size. The tools bearer may have a linear or rotational design.

The present application relates to a closing machine for closing of bottles or like containers with closures, with several closing stations or closing arrangements disposed at a rotating rotor configured to be rotated rotor, and respectively with a drive arrangement for closing and/or fixing of containers being provided which is configured for respectively securing of the closure to the respective container located in the closing station or closing arrangement, in one possible embodiment under use of a closing tool or arrangement operated by the drive arrangement for closing.

One feature or aspect of an embodiment is believed at the time of the filing of this patent application to possibly reside broadly in a closing machine for closing of bottles or like containers 1 with closures 2, with several closing stations or closing arrangements 5 that are disposed at a circulating rotor 4 configured to be rotated, and are respectively provided with one closing tool or arrangement 11, 12 for securing of the closure 2 to the container 1 that is disposed at a respective closing station or closing arrangement 5, wherein that to every closing station or closing arrangement 5 there are provided two closing tools or arrangements 11, 12 that are held at one tools bearer 10, and that by moving of the tools bearer 10 the closing tools or arrangements 11, 12 of at least one closing station or closing arrangement 5 can be moved, for the purpose of effecting a tool exchange or a format and/or size exchange, between a working position, in which the closing tool or arrangement effectuates the fixing of closures 2 at containers 1 and a loading position.

Another feature or aspect of an embodiment is believed at the time of the filing of this patent application to possibly reside broadly in the closing machine, comprising a drive arrangement for closing, that is configured to provide a sufficient force for the closing tools or arrangements 11, 12 in every closing station or closing arrangement 5, and the closing tools or arrangements 11, 12 are associated, while in the working position, at least during the process of closing until completion of the closing process of the closures 2 at the containers 1, with the drive arrangement and the closing tools being configured to be uncoupled, while in the supplying position, from the drive arrangement for closing.

Yet another feature or aspect of an embodiment is believed at the time of the filing of this patent application to possibly reside broadly in the configuration of the machine for closing of the containers 1 with the closures 2 wherein closing is performed by a turning or screwing movement, wherein closing tools or arrangements 10 comprise conically shaped closing structures or arrangements 11, 12 which are journaled in such a way that they can rotate.

Still another feature or aspect of an embodiment is believed at the time of the filing of this patent application to possibly reside broadly in the closing machine, wherein that the drive arrangement for closing of every closing station or closing arrangement 5 is formed by an assembly comprising a drive motor and a spindle arrangement 8 configured for turning a closure to secure the closure, as driven by the drive motor.

A further feature or aspect of an embodiment is believed at the time of the filing of this patent application to possibly reside broadly in the closing machine, wherein that the closing tools or arrangements 11, 12 are disposed in the tools bearer 10 so as to be moved in axial direction.

Another feature or aspect of an embodiment is believed at the time of the filing of this patent application to possibly reside broadly in the closing machine, wherein that for carrying out exchange of the tools, the tools bearer 10 is moveable in a direction which is tangential with respect to the rotating movement A of the rotor 4.

Yet another feature or aspect of an embodiment is believed at the time of the filing of this patent application to possibly reside broadly in the closing machine, wherein that the tools bearer 10, is a ring 10, or a ring segment or ring portion, which is arranged or which is coordinated with respect to the machine axis MA such that respective so as to be coincidentally disposed with respect to one another.

Still another feature or aspect of an embodiment is believed at the time of the filing of this patent application to possibly reside broadly in the closing machine, comprising connecting or clutch means 8.1, 11.1, 12.1 for connecting of the closing tool or arrangement 11, 12, while the closing tool or arrangement 11, 12 is in the working position, to the drive arrangement for closing 7, 8.

A further feature or aspect of an embodiment is believed at the time of the filing of this patent application to possibly reside broadly in the closing machine, wherein that the connecting or clutch means are formed in each case by a clutch segment 8.1 at the spindles 8 as well as by a suitable clutch segments 11.1, 12.1 at the closing tools 11, 12.

Another feature or aspect of an embodiment is believed at the time of the filing of this patent application to possibly reside broadly in the closing machine, comprising means 9.1 for arresting of the closing tools or arrangements 11, 12 disposed in the supplying position, against movements, in one possible embodiment against turning movements in a given position.

One other feature or aspect of an embodiment is believed at the time of the filing of this patent application to possibly reside broadly in a closing machine 3 for screwing caps 2 onto screw top bottles 1 in a beverage bottling plant 100, closing machine 3 comprises a centrally oriented vertical machine axis MA, a rotor 4 centrally oriented with machine axis MA, a plurality of closing units 6 substantially equally spaced about a perimeter of rotor 4, each of the closing units 6 comprise a drive unit 7 with a downwardly depending spindle 8, the drive unit being configured to rotate the spindle about its longitudinal vertical axis, a ridge 8.1 depending downward from a lower portion of each of the spindles 8, a centering ring 9 centrally oriented with the machine axis MA having a plurality of substantially equally spaced apertures 13 configured to receive a lower portion of each of the spindles 8, a ridge 9.1 depending downward from the centering ring 9 around the machine axis MA between each of the apertures 13, the ridges 8.1 depending downward from each of the spindles 8 and the ridge 9.1 depending downward from the centering ring 9 being configured to form a partially continuous ridge around the machine axis MA when the spindles 8 are rotated to a tool changing orientation, a tools bearer 10 centrally oriented with the machine axis MA below and proximate the partially continuous ridge, a bottle holder 15 below the tools bearer 10 configured to dispose a bottle 1 below each of the spindles 8 to permit screwing of caps 2 onto the bottles 1, a plurality of first closing tools 11 rotatably disposed in the tools bearer 10, each being spaced about the machine axis MA to cooperate with one of the spindles 8, a second closing tool 12 rotatably disposed in the tools bearer 10 between each of the first closing tools 11, the first closing tools 11 being configured to receive and rotate a cap 2 of a first size and the second closing tools 12 being configured to receive and rotate a cap 2 of a second size, the first size being different than the second size, a slot 11.1 or 12.1 in an upper portion of each of the first 11 and second closing tools 12 above the tools bearer 10 configured to slidingly receive the partial continuous ridge, the tools bearer 10 being configured to rotate to a first operable orientation disposing each of the first tools 11 in an operable location wherein each of the slots 11.1 of the first tools 11 receives one of the ridges 8.1 of the spindles 8 to screw the caps 2 of a first size onto the bottles 1 and disposing each of the second tools 12 in a non-operable location wherein each of the slots 12.1 in the second tools 12 receives a portion of the ridge 9.1 depending downward from the centering ring 9, the tools bearer 10 being configured to rotate to a second operable orientation disposing each of the second tools 12 in an operable location wherein each of the slots 12.1 of the second tools 12 receives one of the ridges 8.1 of the spindles 8 to screw the caps 2 of a second size onto the bottles 1 and disposing each of the first tools 11 in a non-operable location wherein each of the slots 11.1 in the first tools 11 receives a portion of the ridge 9.1 depending downward from the centering ring 9, and a rotational apparatus configured to rotate the tools bearer 10 between the first and second operable orientations.

Another feature or aspect of the embodiment is believed at the time of the filing of this patent application to possibly reside broadly in a closing machine 3 wherein each of the apertures 13 in the centering ring 9 is configured to guide the spindles 8 toward the first and the second closing tools 11 and 12.

Yet another feature or aspect of the embodiment is believed at the time of the filing of this patent application to possibly reside broadly in a closing machine 3 comprising a third closing tool rotatably disposed in the tools bearer 10 between each pair of the first and the second closing tools 11 and 12, the third closing tools being configured to receive and rotate a cap 2 of a third size, the third size being different than the first and second sizes.

Still another feature or aspect of the embodiment is believed at the time of the filing of this patent application to possibly reside broadly in a closing machine 3 wherein each of the first and the second closing tools 11 and 12 are rotatably held within the tools bearer 10 with a bearing element and each of the first and the second closing tools are configured to move in an axial direction within the tools bearer 10.

A further feature or aspect of the embodiment is believed at the time of the filing of this patent application to possibly reside broadly in a closing machine 3 for screwing caps 2 onto screw type bottles 1 comprising a rotor 4, a plurality of closing units 6 substantially equally spaced proximate a perimeter of the rotor 4, each of the closing units 6 comprising a drive unit 7, each of the drive units 7 comprising a downwardly depending spindle 8, each of the drive units 7 being configured to rotate the spindle 8 depending therefrom about its axis, a tools bearer 10 below and proximate a lower portion of the spindles 8, a bottle holder 15 below the tools bearer 10 configured to dispose a bottle 1 below each of the spindles 8 to permit screwing of caps 2 onto the bottles 1, a plurality of first closing tools 11 rotatably disposed in the tools bearer 10, each being spaced proximate a perimeter thereof to cooperate with one of the spindles 8, a second closing tool 12 rotatably disposed in the tools bearer 10 between each of the first closing tools 11, the first closing tools 11 being configured to receive and rotate a cap 2 of a first size and the second closing tools 12 being configured to receive and rotate a cap of a second size 2, the first size being different than the second size, the tools bearer 10 being configured to rotate to a first operable orientation disposing a first tool 11 to operably engage each of the spindles 8 to screw the caps 2 of a first size onto the bottles 1 and disposing one of the second tools 12 in a non-operable location between each of the first tools 11, the tools bearer 10 being configured to rotate to a second operable orientation disposing a second tool 12 to operably engage each of the spindles 8 to screw the caps 2 of a second size onto the bottles 1 and disposing one of the first tools 11 in a non-operable location between each of the second tools 12, and a rotational apparatus configured to rotate the tools bearer 10 between the first and second operable orientations.

Another further feature or aspect of the embodiment is believed at the time of the filing of this patent application to possibly reside broadly in a closing machine 3 wherein each of the drive units 6 comprises a motor 7 configured to provide a sufficient torque to the spindle 8 depending downwardly therefrom for the closing of the bottles 1 with the first and the second size caps 2.

Yet another feature or aspect of the embodiment is believed at the time of the filing of this patent application to possibly reside broadly in a closing machine 3 wherein an upper portion of each of the first and the second closing tools 11 and 12 comprise a first portion of a clutch means, the first portion of a clutch means comprises a slot 11.1 or 12.1 configured for cooperatively receiving a portion of one of the spindles 8 for closing.

Still another feature or aspect of the embodiment is believed at the time of the filing of this patent application to possibly reside broadly in a a closing machine 3 wherein each of the slots 11.1 and 12.1 is arced and each of the lower portions of the spindles 8 comprise a second portion of a clutch means, the second portion of a clutch means comprises an arced ridge 8.1 configured to be slidingly received by the slots 11.1 and 12.1 with the rotation of the tools bearer 10 when the spindles 8 and the first and the second tools 11 and 12 are in a tool changing orientation.

A further feature or aspect of the embodiment is believed at the time of the filing of this patent application to possibly reside broadly in a closing machine according 3 comprising a centering ring 9 comprising a plurality of substantially equally spaced apertures 13 configured to receive and guide a lower portion of each of the spindles 8.

Another further feature or aspect of the embodiment is believed at the time of the filing of this patent application to possibly reside broadly in a closing machine 3 wherein the centering ring 9 comprises an arced ridge 9.1 depending downward therefrom between each of the apertures 13 configured to form a partially continuous ridge with the arced ridges 8.1 on the lower portions of the spindles 8 when the spindles 8 are rotated to a tool changing orientation, the arced ridge 9.1 depending downward from the centering ring 9 being configured to dispose the first or the second tools, 11 or 12, at the non-operable location in the tool changing orientation.

Yet another further feature or aspect of the embodiment is believed at the time of the filing of this patent application to possibly reside broadly in a closing machine 3 wherein the first tools 11 comprise a conically shaped cap receiving structure for receiving the caps 2 of the first size and the second tools 12 comprise a conically shaped cap receiving structure for receiving the caps 2 of the second size.

Another feature or aspect of the embodiment is believed at the time of the filing of this patent application to possibly reside broadly in a closing machine 3 comprising at least a third closing tool rotatably disposed in the tools bearer 10 between the first and second closing tools 11 and 12, the third closing tools being configured to receive and rotate a cap 2 of a third size, the third size being different than the first and the second sizes.

Yet another feature or aspect of the embodiment is believed at the time of the filing of this patent application to possibly reside broadly in a closing machine 3 comprising a rotational apparatus configured to rotate the tools bearer 10 between the first and second operable orientations, the tools bearer 10 being moveable in a direction which is tangential with respect to the rotating movement of the rotor 4.

One other feature or aspect of an embodiment is believed at the time of the filing of this patent application to possibly reside broadly in a closing machine 306 configured to close containers 1 with a screw type closure 2 comprising, a tools bearer, at least one group of tools disposed with the tools bearer, each of the at least one group of tools comprising a first tool 11 with a closure receiver configured to receive a screw type closure 2 of a first size and a second tool 12 with a closure receiver configured to receive a screw type closure 2 of a second size, the first and the second sizes are different, and wherein the first and the second tool 11 and 12 in each of the at least one group of tools is configured to rotate in the tools bearer, at least one rotator apparatus configured to rotate at least one of the first or the second tools 11 and 12 with a torque sufficient to close the containers 2 with the screw type closures 1, the tools bearer 10 being configured to move the first tool 11 in each of the at least one group of tools into an operable position for engagement with one of the screw type closures 2 of the first size and to move the second tool 12 in each of the at least one group of tools into a non-operable position out of engagement with the screw type closures 2 of the first size, and the tools bearer being configured to move the second tool 12 in each of the at least one group of tools into an operable position for engagement with one of the screw type closures 2 of the second size and to move the first tool 11 in each of the at least one group of tools into a non-operable position out of engagement with the screw type closures 2 of the second size.

Yet another feature or aspect of the embodiment is believed at the time of the filing of this patent application to possibly reside broadly in a closing machine 306 comprising a plurality of groups of tools disposed with the tools bearer, at least one rotator apparatus configured to rotate each of the groups of tools, the tools bearer being configured to move the first tool or the second tool, 11 or 12, in each of the groups of tools into an operable position in engagement with one of the at least one rotator apparatus and to move the other of the first or the second tool, 11 or 12, of the plurality of groups of tools into a non-operable position out of engagement with each of the at least one rotator apparatus.

Still another feature or aspect of the embodiment is believed at the time of the filing of this patent application to possibly reside broadly in a closing machine 306 wherein the tools bearer comprises a ring shaped portion in which the plurality of groups of tools are disposed substantially equidistantly about a perimeter thereof, each of the at least one rotator apparatus being oriented to rotate one of the first size or the second size tools, 11 or 12, in each of the plurality of groups of tools and a rotation of the ring shaped portion of the tools bearer moves the other of the first size or the second size tools, 11 or 12, in each of the plurality of groups of tools to be rotated by one of the at least one rotator apparatus.

A further feature or aspect of the embodiment is believed at the time of the filing of this patent application to possibly reside broadly in a closing machine 306 wherein each of the at least one rotator apparatus comprise a first portion of a clutch means and the tools of the first and the second size, 11 and 12, comprise a second portion of a clutch means, the first portion of a clutch means being configured to operably engage the second portion of a clutch means, the first portion of a clutch means comprises a key extending from each of the at least one rotator apparatus and the portion of a clutch means comprises a slot in each of the tools of the first and the second size configured to slidingly receive the key.

Another further feature or aspect of the embodiment is believed at the time of the filing of this patent application to possibly reside broadly in a closing machine 306 comprising a centering arrangement 9 comprising a plurality of apertures 13, a spindle 8 extending from each of the at least one rotator apparatus configured to rotate the tools aa and 12 of the first and the second size, and each of the apertures 13 in the centering arrangement 9 being configured to receive and guide the spindle 8 extending from each of the at least one rotator apparatus.

Yet another feature or aspect of the embodiment is believed at the time of the filing of this patent application to possibly reside broadly in a closing machine 306 wherein the centering arrangement 9 comprising an extension 9.1 configured to be slidingly received by the slots 11.1 and 12.1 in the tools 11 and 12 of the first and the second size maintaining the tools of the first size 11 or the second size 12 in the non-operable position in an orientation to slidingly receive the key 8.1 extending from the spindles 8.

Still another feature or aspect of the embodiment is believed at the time of the filing of this patent application to possibly reside broadly a closing machine 306 in combination with a bottling plant 300 comprising a container rinsing station 301 configured to rinse the containers 1, a beverage filling machine 305 configured to receive the containers 1 from the container rinsing station 301 and fill the containers 1 with a beverage, and the closing machine 306 being configured to receive filled containers 1 from the filling machine 305 and to receive, dispose, and screw one of the screw type closures 2 onto one of the containers 1.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that any or all the examples of patents, published patent applications, and other documents which are included in this application and including those which are referred to in paragraphs which state “Some examples of . . . which may possibly be used in at least one possible embodiment of the present application . . . ” may possibly not be used or useable in any one or more or any embodiments of the application.

The sentence immediately above relates to patents, published patent applications and other documents either incorporated by reference or not incorporated by reference.

Some examples of closing machines and other features which may possibly be utilizable by at least one possible embodiment of the present application may possibly be found in the following: U.S. Pat. No. 7,415,816, having inventor Herbert Bernhard, Wolfsheim; U.S. Pat. No. 7,325,372, having inventor Herbert Bernhard, Wolfsheim; and U.S. patent application Ser. No. 10/982,694, having inventor Herbert Bernhard, Wolfsheim.

U.S. patent application Ser. No. 12/353,999, filed on Jan. 15, 2009, having inventor Volker TILL, Attorney Docket No. NHL-HOL-209, and title “A ROTARY BEVERAGE BOTTLE FILLING MACHINE CONFIGURED TO FILL BEVERAGE BOTTLES WITH DIFFERENT DIAMETERS, SIZES, AND SHAPES WITHOUT CHANGING BOTTLE CARRIERS AND A CONTAINER TREATMENT MACHINE CONFIGURED TO HANDLE CONTAINERS WITH DIFFERENT DIAMETERS, SIZES, AND SHAPES WITHOUT CHANGING CONTAINER CARRIERS,” and its corresponding Federal Republic of Germany Patent Application No. 10 2006 033 511.2, filed on Jul. 20, 2006, and International Patent Application No. PCT/EP2007/006306, filed on Jul. 17, 2007, having WIPO Publication No. WO 2008/009408 and inventor Volker TILL are hereby incorporated by reference as if set forth in their entirety herein.

Some examples of stepping motors that may possibly be utilized or possibly adapted for use in at least one possible embodiment of the present application may possibly be found in the following U.S. patents: No. 6,348,774 issued to Andersen et al. on Feb. 19, 2002; No. 6,373,209 issued to Gerber et al. on Apr. 16, 2002; No. 6,424,061 issued to Fukuda et al. on Jul. 23, 2002; No. 6,509,663 issued to Aoun on Jan. 21, 2003; No. 6,548,923 to Ohnishi et al. on Apr. 15, 2003; and No. 6,661,193 issued to Tsai on Dec. 9, 2003.

Some examples of servo-motors that may possibly be utilized or possibly adapted for use in at least one possible embodiment of the present application may possibly be found in the following U.S. patents: No. 4,050,434 issued to Zbikowski et al. on Sep. 27, 1977; No. 4,365,538 issued to Andoh on Dec. 28, 1982; No. 4,550,626 issued to Brouter on Nov. 5, 1985; No. 4,760,699 issued to Jacobsen et al. on Aug. 2, 1988; No. 5,076,568 issued to de Jong et al. on Dec. 31, 1991; and No. 6,025,684 issued to Yasui on Feb. 15, 2000.

Some examples of synchronous motors which may possibly be utilized or adapted for use in at least one possible embodiment may possibly be found in the following U.S. Pat. No. 6,713,899, entitled “Linear synchronous motor;” No. 6,486,581, entitled “Interior permanent magnet synchronous motor;” No. 6,424,114, entitled “Synchronous motor;” No. 6,388,353, entitled “Elongated permanent magnet synchronous motor;” No. 6,329,728, entitled “Cylinder-type linear synchronous motor;” No. 6,025,659, entitled “Synchronous motor with movable part having permanent magnets;” No. 5,936,322, entitled “Permanent magnet type synchronous motor;” and No. 5,448,123, entitled “Electric synchronous motor.”

Some examples of quick change systems which may possibly be adapted for use or utilized in the present application may possibly be found in the following U.S. Pat. No. 5,778,633, having the title “QUICK CHANGE LEDGE SUPPORT ASSEMBLY FOR FILLING AND CAPPING MACHINES,” published on Jul. 14, 1998; No. 5,711,411, having the title “QUICK CHANGEOVER FILLING, CENTERING BRACKET,” published on Jan. 27, 1998; No. 5,671,585, having the title “QUICK CHANGE CONNECTION FOR FILLING AND CAPPING MACHINES,” published on Sep. 30, 1997; and No. 4,635,662, having the title “INLINE BOTTLE RINSER WITH QUICK BOTTLE SIZED CHANGEOVER CAPABILITY,” published on Jan. 13, 1987.

The following patents, patent applications or patent publications, are hereby incorporated by reference as if set forth in their entirety herein: WO 03/070579A1, having the title “PLASTIC WATER BOTTLE AND APPARATUS AND METHOD TO PREVENT BOTTLE ROTATION,” published on Aug. 28, 2003.

All of the patents, patent applications or patent publications, which were cited in the International Search Report dated Nov. 16, 2007, in response to the PCT priority application PCT/EP2007/006306 for U.S. application Ser. No. 12/353,999, having the attorney docket number NHL-HOL-209 and/or cited elsewhere are hereby incorporated by reference as if set forth in their entirety herein as follows: WO 2006/077050, having the English equivalent of the German title “METHOD AND DEVICE FOR HOLDING VESSELS,” published on Jul. 27, 2006; EP 1,512,663, having the following German title “VORRICHTUNG ZUM WECHSELN VON AN UMLAUFENDEN BEHÄLTERBEHANDLUNGSMASCHINEN ANGEORDNETEN BAUTEILEN,” published on Mar. 9, 2005; and U.S. Pat. No. 5,778,633, having the title “QUICK CHANGE LEDGE SUPPORT ASSEMBLY FOR FILLING AND CAPPING MACHINES,” published on Jul. 14, 1998.

All of the patents, patent applications or patent publications, which were cited in the German Office Action dated Jun. 12, 2007, in response to the German priority application 10 2006 033 511.2 for U.S. application Ser. No. 12/353,999, having the attorney docket number NHL-HOL-209, and/or cited elsewhere are hereby incorporated by reference as if set forth in their entirety herein as follows: DE 10 2005 002 715, having the following English translation of the German title “METHOD AND DEVICE FOR HOLDING VESSELS,” published on Aug. 3, 2006; DE 701 799, having the following German title “VORRICHTUNG ZUR VERAENDERUNG DER FUELLHOEHE,” published on Jan. 23, 1941; and DE 103 40 365, having the following German title “VORRICHTUNG ZUM WECHSELN VON AN UMLAUFENDEN BEHÄLTERBEHANDLUNGSMASCHINEN ANGEORDNETEN BAUTEILEN,” published on Mar. 24, 2005.

U.S. patent application Ser. No. 10/931,817, filed on Sep. 1, 2004, having inventor Dieter-Rudolf KRULITSCH, Attorney Docket No. NHL-HOL-82, and title “A BEVERAGE BOTTLING PLANT FOR FILLING BOTTLES WITH A LIQUID BEVERAGE FILLING MATERIAL, HAVING AN APPARATUS FOR EXCHANGING OPERATING UNITS DISPOSED AT ROTATING CONTAINER HANDLING MACHINES,” and its corresponding Federal Republic of Germany Patent Application No. DE 103 40 8365.5, filed on Sep. 2, 2003 and inventor Dieter-Rudolf KRULITSCH are hereby incorporated by reference as if set forth in their entirety herein.

All of the patents, patent applications or patent publications, which were cited in the International Search Report dated Nov. 19, 2007, and/or cited elsewhere are hereby incorporated by reference as if set forth in their entirety herein as follows: EP 1,529,751, having the following English translation of the German title “BEVERAGE BOTTLING PLANT FOR FILLING BOTTLES WITH A LIQUID BEVERAGE FILLING MATERIAL HAVING A CLOSING MACHINE FOR CLOSING CONTAINERS,” published May 11, 2005; and EP 1,273,551, having the title “CAPPING MACHINE WITH A CAPPING HEAD,” published on Jan. 8, 2003.

The patents, patent applications, and patent publications listed above, beginning on line 1087 on page 46 in the paragraph with the statement: “Some examples of closing machines . . . ” and ending on line 1201 on page 51 in the paragraph with the phrase: “ . . . published on Jan. 8, 2003,” are herein incorporated by reference as if set forth in their entirety. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2006 035 279.3, filed on Jul. 31, 2006, having inventor Volker TILL, and DE-OS 10 2006 035 279.3 and DE-PS 10 2006 035 279.3, and International Application No. PCT/EP2007/006324, filed on Jul. 17, 2007, having WIPO Publication No. WO 2008/014883 and inventor Volker TILL, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The corresponding foreign and international patent publication applications, namely, Federal Republic of Germany Patent Application No. 10 2006 033 511.2, filed on Jul. 20, 2006, having inventor Volker TILL, and DE-OS 10 2006 033 511.2 and DE-PS 10 2006 033 511.2, and International Application No. PCT/EP2007/006306, filed on Jul. 17, 2007, having WIPO Publication No. WO 2008/009408 and inventor Volker TILL, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the Foreign equivalent patent application PCT/EP2007/006324, PCT/EP2007/006306, German Patent Application 10 2006 035 279.3, and German Patent Application 10 2006 033 511.2 is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2007/006324, PCT/EP2007/006306, DE 10 2006 035 279.3, and DE 10 2006 033 511.2 from which this patent application claims priority which do not have to do with the correction of the translation in this patent application are not to be included in this patent application in the incorporation by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

1 Bottle
1.1 Threading at the bottle mouth
1.2 Bottle flange
2 Closure
3 Closing machine
4 Rotor
5 Closing station or closing arrangement
6 Closing structure or arrangement
7 Drive arrangement for closing
8 Spindle arrangement configured for turning a closure to secure the closure
8.1 Connecting or clutch segment
8.1.1 Lateral surface or side
9 Centering and positioning or securing ring or arrangement
9.1 Ridge or bar or keying or feathering formation
9.1.1 Lateral surface or side of element 9.1
10 Supporting or carrying ring or tools bearer
11, 12 Conically shaped closing structure or arrangement
11.1, 12.1 Connecting or clutch segment at the upper side of the conically shaped closing structure or arrangement
13 Guidance bore or passage
14 Gap or groove
15 Container bearer
A Direction of rotation of the rotor 4
B Direction of the controlled lifting and lowering movement of the container bearers 15
MA Machine axis

What is claimed is:

1. A closing machine for screwing caps onto screw top bottles in a beverage bottling plant, said closing machine comprising:
a centrally oriented vertical machine axis;
a rotor centrally oriented with said machine axis;
a plurality of closing units substantially equally spaced about a perimeter of said rotor;
each of said closing units comprising a drive unit with a downwardly depending spindle, said drive unit being configured to rotate said spindle about its longitudinal vertical axis;
a ridge depending downward from a lower portion of each of said spindles;
a centering ring centrally oriented with said machine axis having a plurality of substantially equally spaced apertures configured to receive a lower portion of each of said spindles;
a ridge depending downward from said centering ring around said machine axis between each of said apertures;
said ridges depending downward from each of said spindles and said ridge depending downward from said centering ring being configured to form a partially continuous ridge around said machine axis when said spindles are rotated to a tool changing orientation;
a tools bearer centrally oriented with said machine axis below and proximate said partially continuous ridge;
a bottle holder below said tools bearer configured to dispose a bottle below each of said spindles to permit screwing of caps onto said bottles;
a plurality of first closing tools rotatably disposed in said tools bearer, each being spaced about said machine axis to cooperate with one of said spindles;
a second closing tool rotatably disposed in said tools bearer between each of said first closing tools;
said first closing tools being configured to receive and rotate a cap of a first size and said second closing tools being configured to receive and rotate a cap of a second size;
said first size being different than said second size;
a slot in an upper portion of each of said first and second closing tools above said tools bearer configured to slidingly receive said partial continuous ridge;
said tools bearer being configured to rotate to a first operable orientation disposing each of said first tools in an operable location wherein each of said slots of said first tools receives one of said ridges of said spindles to screw said caps of a first size onto said bottles and disposing each of said second tools in a non-operable location wherein each of said slots in said second tools receives a portion of said ridge depending downward from said centering ring;
said tools bearer being configured to rotate to a second operable orientation disposing each of said second tools in an operable location wherein each of said slots of said second tools receives one of said ridges of said spindles to screw said caps of a second size onto said bottles and disposing each of said first tools in a non-operable location wherein each of said slots in said first tools receives a portion of said ridge depending downward from said centering ring; and
a rotational apparatus configured to rotate said tools bearer between said first and second operable orientations.

2. The closing machine of claim 1, wherein each of said apertures in said centering ring is configured to guide said spindles toward said first and said second closing tools.

3. The closing machine of claim 2, comprising a third closing tool rotatably disposed in said tools bearer between each pair of said first and said second closing tools, said third closing tools being configured to receive and rotate a cap of a third size, said third size being different than said first and second sizes.

4. The closing machine of claim 3, wherein each of said first and said second closing tools are rotatably held within said tools bearer with a bearing element and each of said first and said second closing tools are configured to move in an axial direction within said tools bearer.

5. A closing machine for screwing caps onto screw type bottles comprising:
a rotor;
a plurality of closing units substantially equally spaced proximate a perimeter of said rotor;
each of said closing units comprising a drive unit;
each of said drive units comprising a downwardly depending spindle;
each of said drive units being configured to rotate said spindle depending therefrom about its axis;
a tools bearer below and proximate a lower portion of said spindles;
a bottle holder below said tools bearer configured to dispose a bottle below each of said spindles to permit screwing of caps onto said bottles;
a plurality of first closing tools rotatably disposed in said tools bearer, each being spaced proximate a perimeter thereof to cooperate with one of said spindles;
a second closing tool rotatably disposed in said tools bearer between each of said first closing tools;
said first closing tools being configured to receive and rotate a cap of a first size and said second closing tools being configured to receive and rotate a cap of a second size;
said first size being different than said second size;
said tools bearer being configured to rotate to a first operable orientation disposing a first tool to operably engage each of said spindles to screw said caps of a first size onto said bottles and disposing one of said second tools in a non-operable location between each of said first tools;
said tools bearer being configured to rotate to a second operable orientation disposing a second tool to operably engage each of said spindles to screw said caps of a second size onto said bottles and disposing one of said first tools in a non-operable location between each of said second tools; and
a rotational apparatus configured to rotate said tools bearer between said first and second operable orientations.

6. The closing machine in accordance with claim 5, wherein each of said drive units comprises a motor configured to provide a sufficient torque to said spindle depending downwardly therefrom for the closing of said bottles with said first and said second size caps.

7. The closing machine according to claim 6, wherein an upper portion of each of said first and said second closing tools comprise a first portion of a clutch means, said first portion of a clutch means comprises a slot configured for cooperatively receiving a portion of one of said spindles for closing.

8. The closing machine according to claim 7, wherein each of said slots is arced and each of said lower portions of said spindles comprise a second portion of a clutch means, said second portion of a clutch means comprises an arced ridge configured to be slidingly received by said slots with the rotation of said tools bearer when said spindles and said first and said second tools are in a tool changing orientation.

9. The closing machine according to claim 8, further comprising a centering ring comprising a plurality of substantially equally spaced apertures configured to receive and guide a lower portion of each of said spindles.

10. The closing machine according to claim 9, wherein said centering ring comprises an arced ridge depending downward therefrom between each of said apertures configured to form a partially continuous ridge with said arced ridges on said lower portions of said spindles when said spindles are rotated to a tool changing orientation, said arced ridge depending downward from said centering ring being configured to dispose said first or said second tools at said non-operable location in said tool changing orientation.

11. The closing machine of claim 10, wherein said first tools comprise a conically shaped cap receiving structure for receiving said caps of said first size and said second tools comprise a conically shaped cap receiving structure for receiving said caps of said second size.

12. The closing machine of claim 5, comprising at least a third closing tool rotatably disposed in said tools bearer between said first and second closing tools, said third closing tools being configured to receive and rotate a cap of a third size, said third size being different than said first and said second sizes.

13. The closing machine according to claim 5, further comprising a rotational apparatus configured to rotate said tools bearer between said first and second operable orientations, said tools bearer being moveable in a direction which is tangential with respect to the rotating movement of said rotor.

14. A closing machine configured to close containers with a screw type closure comprising:
a tools bearer;
at least one group of tools disposed with said tools bearer;
each of said at least one group of tools comprising a first tool with a closure receiver configured to receive a screw type closure of a first size and a second tool with a closure receiver configured to receive a screw type closure of a second size, said first and said second sizes are different, and wherein said first and said second tool in each of said at least one group of tools is configured to rotate in said tools bearer;
at least one rotator apparatus configured to rotate at least one of said first or said second tools with a torque sufficient to close said containers with said screw type closures;
said tools bearer being configured to move said first tool in each of said at least one group of tools into an operable position for engagement with one of said screw type closures of said first size and to move said second tool in each of said at least one group of tools into a non-operable position out of engagement with said screw type closures of said first size; and
said tools bearer being configured to move said second tool in each of said at least one group of tools into an operable position for engagement with one of said screw type closures of said second size and to move said first tool in each of said at least one group of tools into a non-operable position out of engagement with said screw type closures of said second size.

15. The closing machine of claim 14, further comprising;
a plurality of groups of tools disposed with said tools bearer;
at least one rotator apparatus configured to rotate each of said groups of tools;
said tools bearer being configured to move said first tool or said second tool in each of said groups of tools into an operable position in engagement with one of said at least one rotator apparatus and to move the other of said first or said second tool of said plurality of groups of tools into a non-operable position out of engagement with each of said at least one rotator apparatus.

16. The closing machine of claim 15, wherein said tools bearer comprises a ring shaped portion in which said plurality of groups of tools are disposed substantially equidistantly about a perimeter thereof, each of said at least one rotator apparatus being oriented to rotate one of said first size or said second size tools in each of said plurality of groups of tools and a rotation of said ring shaped portion of said tools bearer moves the other of said first size or said second size tools in each of said plurality of groups of tools to be rotated by one of said at least one rotator apparatus.

17. The closing machine of claim 16, wherein each of said at least one rotator apparatus comprise a first portion of a clutch means and said tools of said first and said second size comprise a second portion of a clutch means, said first portion of a clutch means being configured to operably engage said second portion of a clutch means, said first portion of a clutch means comprises a key extending from each of said at least one rotator apparatus and said portion of a clutch means comprises a slot in each of said tools of said first and said second size configured to slidingly receive said key.

18. The closing machine of claim 17, further comprising:
a centering arrangement comprising a plurality of apertures;
a spindle extending from each of said at least one rotator apparatus configured to rotate said tools of said first and said second size; and
each of said apertures in said centering arrangement being configured to receive and guide said spindle extending from each of said at least one rotator apparatus.

19. The closing machine of claim 18, wherein said centering arrangement comprising an extension configured to be slidingly received by said slots in said tools of said first and said second size maintaining said tools of said first size or said second size in said non-operable position in an orientation to slidingly receive said key extending from said spindles.

20. The closing machine of claim 14, in combination with a bottling plant comprising:
a container rinsing station configured to rinse said containers;
a beverage filling machine configured to receive said containers from said container rinsing station and fill said containers with a beverage; and
said closing machine being configured to receive filled containers from said filling machine and to receive, dispose, and screw one of said screw type closures onto one of said containers.
